(19) United States
(12) Patent Application Publication
(10) Pub. No.: US 2003/0094718 A1
(43) Pub. Date: May 22, 2003

(54) Extrusion plant

(76) Inventors: Berthold Droege, Gramatneusiedl (AT); Nick King, Durham (GB); Frank Van Lueck, Vienna (AT)

Correspondence Address: DONALD J. SHADE, C/O BATTENFELD GLOUCESTER ENGINEERING CO., INC., P.O. BOX 900, GLOUCESTER, MA, 01931, US

(21) Appl. No.: 10/278,453

(22) Filed: Oct. 23, 2002

(30) Foreign Application Priority Data
Oct. 27, 2001 (DE) DE 101 52 378.5
Oct. 27, 2001 (DE) DE 101 52 379.3

(51) Int. Cl. B29C 44/20

(52) U.S. Cl. 264/40.6; 264/51; 425/4 C; 425/144

(57) ABSTRACT

The invention relates to an extrusion plant for manufacturing foam products such as foamed sheets, foamed boards and foamed profiles, and consists of one melting extruder minimum to melt and homogenise the plastic material and a minimum of two parallel cooling units to cool down the plastic melt prior to extrusion through a die. According to the invention it is planned that the minimum of two parallel cooling units are used that may or may not be identical or that can be controlled by control means so that the expelled plastic melt from these units may or may not have the same material properties.

### FIELD OF THE INVENTION

The invention covers an extrusion line for the manufacture of foam products such as foam sheets, foam boards and foam profiles consisting of one melting and homogenising extruder and a minimum of two cooling units to cool down the polymer melt and a process for manufacturing foam products comprising: a) melting and homogenising of the polymers in a melting and homogenizing extruder, b) splitting the resulting melt flow into a minimum of two flows, c) cooling each melt flow in separate cooling unit, d) recombining the separated and cooled melt flows into one prior to extrusion through an extrusion die.

### BACKGROUND OF THE INVENTION

In the manufacture of thermoplastic foams such as foamed products such as foam sheets, boards and profiles, the thermoplastic resin is melted and homogenised in a first extruder. A blowing agent is injected and mixed into the melt towards the end of the first extruder, and the melt then enters the secondary or cooling extruder. In the cooling extruder heat energy is withdrawn from the melt through the barrel surface. After sufficient withdrawal of energy the plastic melt is foamed after passing through an extrusion die. In some embodiments, the foam process may also include filtration and homogenisation in an additional, mostly static, mixer.

It is known that during manufacturing of thermoplastic resin foams, the second plastic component, i.e. the homogenized resin melt plus blowing agent, is preferably processed at a different, and lower, temperature than the original resin melt. Initially, the available plastic resin is melted. After the plastic resin reaches a reasonable melt quality, the blowing agent, usually gas such as CO₂ or a low boiling hydrocarbon liquid such as pentane, is injected into the resin melt. This changes the flow behaviour of the plastic melt as it is strongly fluidised by the blowing agent addition. A certain stability of the melt is required, however, to obtain stable foam upon exiting the extruder or the die. If the stability is not adequate, bubbles built up during foaming will burst. Cooling the polymer melt as a second step after blowing agent injection increases the viscosity and the stability of the melt.

In smaller extruders, e.g. up to 90 mm diameter extruder size, one extruder can be used to perform both the melting and homogenizing process and the cooling down processes. Beyond a certain extruder size, however, this is no longer functional. In the extruder, the resin melting process is done by external heating of the extruder barrel and by drive power. Typically, the portion of the total energy input due to external heating is between 20-40%, with the remaining energy input supplied by the torque of the screw (shearing). The longer and bigger the extruder, more torque and power has to be installed to operate the screw, and more energy is put into the plastic resin melt because of the shearing action of the screw. Beyond a certain length of the extruder, efficient melt cooling through the barrel surface and into external cooling, as required to obtain melt stability, is not possible because sufficient energy cannot be taken out of the melt to counteract that introduced by the screw.

For this reason, beyond a certain extruder size the foam extrusion process utilizes two separate extruders, whereby the first extruder's duty is to melt the and homogenise the resin and blowing agent and the second extruder's duty is to cool and stabilize the melt. The balance between energy input by the torque of the screw and cooling capacity is obtained by the extruder size and the screw speed. In most cases the cooling extruder is of larger diameter than the melting extruder and operates at a lower screw speed to limit input of energy into the melt. Even utilizing a separate cooling extruder of larger diameter and slower screw speed, as the throughput of the extrusion line increases, the cooling capacity of the cooling extruder becomes the rate-limiting factor. Though a larger extruder size (diameter and length) increases the surface area of the barrel, beyond a certain point enough energy cannot be dissipated through the barrel to offset the power put into the melt by the extruder screw.

A possible solution to this problem was shown in DE 198 48 537 A1. As described, two parallel heat exchangers follow the melting and homogenising extruder. This solution, however, is not controllable and therefore is not used. As the heat exchangers only influence the melt temperature, not temperature and pressure, the two melt streams cannot be stably split. A higher temperature in one of the melt streams causes that stream to flow more quickly while the cooler melt stream flows more slowly. This temperature difference is unstable, and results in the hotter melt stream flowing quicker and quicker, while the cooler flows slower and slower until it eventually freezes.

### SUMMARY OF THE INVENTION

It is therefore an object of the present invention is to provide apparatus and a process that allows the melt stream to be stably split after the melting and homogenising extruder, with each melt stream intensively cooled and recombined prior to extrusion to a foamed product such as foamed sheet, foamed boards or foamed profiles.

It is a further object of the present invention to provide apparatus and process that allows the melt stream to be stably split after the melting and homogenising extruder, with each melt stream independently treated and recombined prior to extrusion to a foamed product such as foamed sheet, foamed boards or foamed profiles.

It is a still further object of the present invention to provide apparatus and process that allows the melt stream to be stably split after the melting and homogenising extruder, with the temperature and pressure of each melt stream independently controlled prior to recombination and extrusion into a foamed product such as foamed sheet, foamed boards or foamed profiles.

In accordance with the present invention apparatus is provided comprising a minimum of two cooling units following the melting and homogenising extruder, each of which has means for pressurizing and forwarding the melt. Each cooling unit may be operated in such fashion that the melt may be treated identically or not identically if so desired during passage through the cooling units. The output from the cooling units are subsequently recombined in a recombining adapter or feedblock and extruded through and extrusion die. The cooling units themselves may be identical, or they may not be. As an example, cooling extruders having different geometries, i.e. diameters and lengths, may be used.

### BRIEF DESCRIPTION OF THE DRAWINGS

FIG. 1 shows a system according to the present invention having two cooling units.

FIG. 2 shows a system according to the present invention utilizing melt pumps associated with the cooling units and a control system.

### DETAILED DESCRIPTION OF THE INVENTION

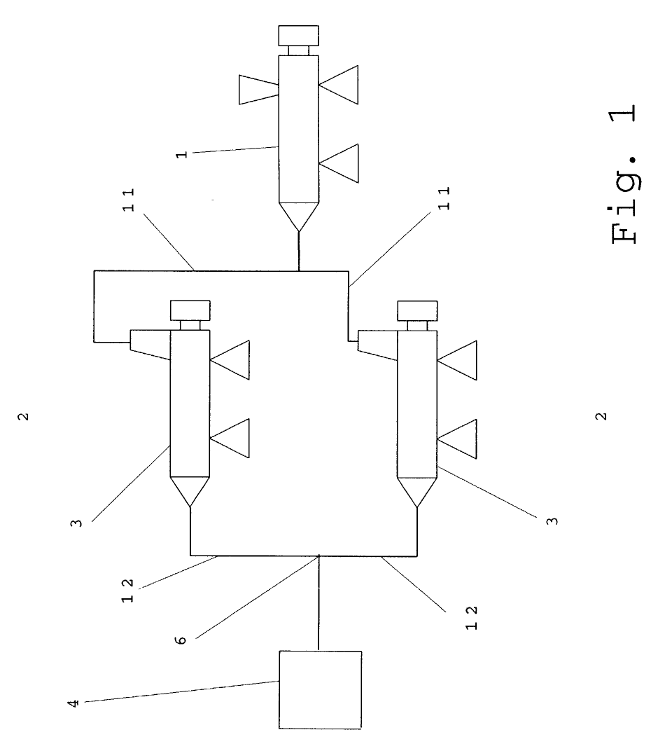

FIG. 1 shows the melting and homogenising extruder 1, in which thermoplastic resin is melted, mixed with a blowing agent and subsequently discharge to an adapter system 11 for delivery to the parallel cooling units 2. As shown in FIG. 1, the melted plastic is separated into two melt flows and fed to the two cooling units 2 through adapter system 11. The cooling units shown in FIG. 1 are cooling extruders 3. The melt flows passing through cooling extruders 3 are directed through melt pipes 12 to recombining adapter or feedblock 6 and are subsequently expelled through extrusion die 4 to form foamed products such as foamed sheet, foamed board or foamed profiles.

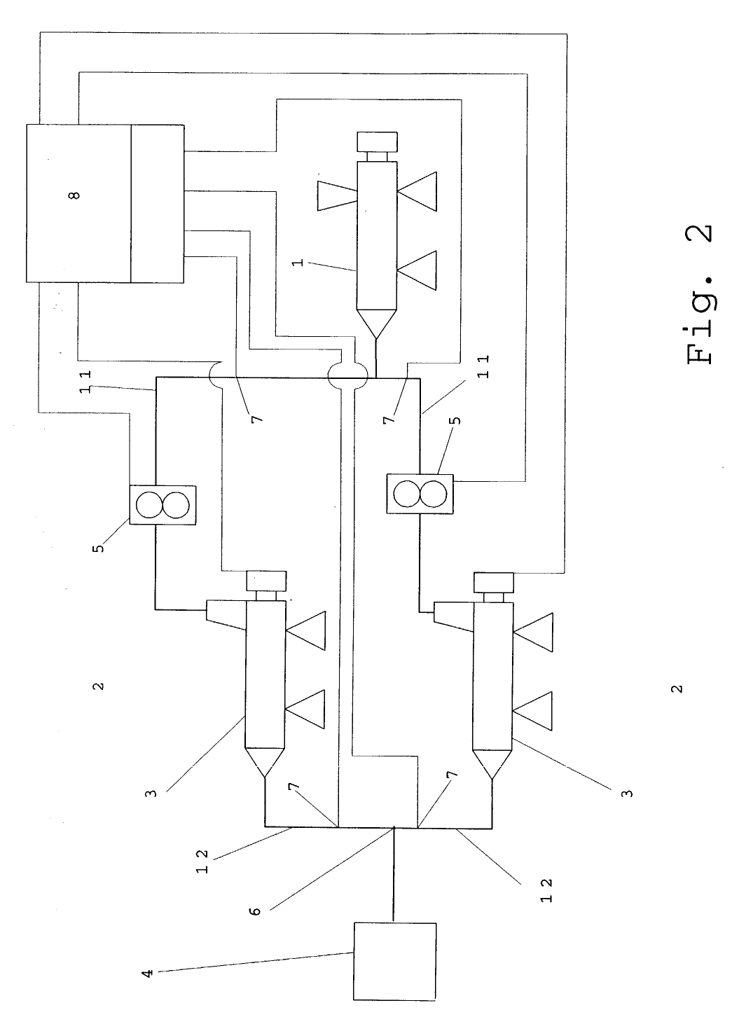

FIG. 2 shows an alternative version of the apparatus in which gear pumps 5 are used in cooling units 2. Although FIG. 2 shows cooling extruders 3 following melt pumps 5, heat exchangers could be used in their place as melt pumps 5 can serve to pressurize and forward the melt. Melt pumps 5 are typically gear pumps. An additional benefit to the use of melt pumps 5 in conjunction with cooling extruders 3 is that the screws used in the cooling extruders 3 can be more easily used to adjust melt pressure, either reducing melt pressure or increasing melt pressure.

As shown in FIG. 2, control system 8 receives various inputs from sensors 7 to control the overall process. These extrusion control systems 8 are well known to those in the plastics processing industry, and are available from numerous suppliers. These sensors may be temperature transducers, pressure transducers or both. If it is desired to obtain essentially the same material properties in the two melt flows at recombining adapter 6, the desired set points may be entered into control unit 8, and the operating parameters, e.g. rpm, temperature, or the heat flows in the cooling units, of the cooling extruder 3 and/or the melt pump 5 can be changed to meet the desired property. If, on the other hand, it is desired to obtain different material properties in the two melt flows at recombining adapter 6, those set points can be provided to control unit 8, and the operating parameters of the cooling extruder 3 and/or the melt pump 5 will be changed to meet the desired setpoint.

It should be understood that the melt properties referred to are primarily temperature and pressure. It is also possible to make certain adjustments to the melt or material properties, as by the addition of additives, such as color concentrate after the melting and homogenising extruder and prior to the cooling extruders.

In operation, the extrusion plant of the present invention operates as follows: Resin, and typically nucleating agents such as talc powder, will be introduced to extruder 1 via the hopper. The resin will be forwarded along the length of extruder by the pumping action of the enclosed extruder screw. The shearing action of the screw and added heat from heaters surrounding the barrel of the extruder will melt the resin. Near the end of the extruder barrel, where the resin is essentially fully melted, the blowing agent will be introduced into the melt. Under the continued action of the screw, the blowing agent will be mixed with the melted resin and forwarded into splitting adapter system 11.

The two streams of resin plus mixed blowing agent travels along splitting adapter system 11 to cooling units 2, which, as shown in FIG. 1, comprise cooling extruders 3. Under the action of the screws in the cooling extruders 3, the melt will be mixed, cooled and forwarded to discharge adapter system 12. The cooled melt streams are rejoined at recombining adapter 6 and are extruded through die 4. The material foams as it exits through die 4.

The temperature and/or pressure in the melt streams entering discharge adapter system 12 may be the same, or they may be different. The preferable way to ensure the properties of the melt streams exiting cooling units 2, which, as shown in both FIG. 1 and FIG. 2 are cooling extruders 3, is through the use of control system 8. As shown in FIG. 2, transducers 7 can monitor the melt temperatures and pressures at several locations. Obviously, the most important location at which to monitor is at the discharge from cooling units 2, i.e. in discharge adapter system 12. The desired temperatures and/or pressures at the discharge from cooling extruders 3 will have previously been entered into control unit 8. The temperatures and/or pressures at the discharge from cooling extruders 3 will be monitored by transducers 7 and supplied to control system 8. Control system 8 in turn will compare the present values of the temperatures and/or pressures at the outlet from cooling units 2 to the desired values, and will adjust the operating parameters of cooling units 2 to bring the present values of the discharge temperatures and/or pressure to the desired values.

While the current invention has been shown and described by reference to the preferred embodiments thereof, it will be understood by those skilled in the art that various changes in form and detail may be made without departing from the spirit and scope of the invention as defined by the following claims.

We claim:

1. An extrusion plant for the manufacture of foamed products comprising a melting and homogenising extruder to melt and homogenise thermoplastic resin and a blowing agent, an adapter system to split the resin melt from the melting and homogenising extruder to the cooling units, a minimum of two parallel cooling units to alter the resin melt properties, a discharge adapter system connecting the cooling units to a recombining adapter, an extrusion die following the recombining adapter and a control system for controlling the cooling units.

2. An extrusion plant according to claim 1 wherein the properties of the melt discharged from the cooling units are essentially identical.

3. An extrusion plant according to claim 2 in which the cooling units are cooling extruders.

4. An extrusion plant according to claim 3 further comprising an extruder screw in the cooling extruder capable of increasing the pressure in the resin melt.

5. An extrusion plant according to claim 2 in which a cooling unit comprises a cooling extruder and a melt pump.

6. An extrusion plant according to claim 5 in which the extruder screw of the cooling extruder is capable of decreasing the pressure in the melt.

7. An extrusion plant according to claim 1 in which the cooling units are melt pumps followed by heat exchangers.

8. An extrusion plant according to claim 1 in which the control system for the cooling units can change the speed of the cooling extruders, whereby the speed of the two cooling units can differ.

9. A process for manufacturing foam products comprising:
a) melting and homogenising plastic in a melting and homogenising extruder,
b) splitting the melt flow from the melting and homogenising extruder into a minimum of two melt flows.
c) influencing the melt flows in different cooling units
d) recombining the minimum of two melt flows into one melt flow and
e) extruding the recombined melt flows through an extrusion die.

10. A process according to claim 9 further comprising influencing the material properties of the two melt flows so that they are nearly identical before recombining.

11. A process according to claim 10 further comprising altering the material properties of pressure and temperature.

12. A process according to claim 11 wherein deviation of the material properties from the desired values results in alteration of the operating parameters of the cooling units, whereby the desired values of the melt properties are obtained.

13. An extrusion plant according to claim 1 wherein the properties of the melt discharged from the cooling units are not identical.

14. An extrusion plant according to claim 13 wherein the cooling units are cooling extruders.

15. An extrusion plant according to claim 14 wherein the extruder screw of the cooling extruder can increase the pressure in the melt.

16. An extrusion plant according to claim 14 wherein the cooling units comprise cooling extruders with a melt pump.

17. An extrusion plant according to claim 16 wherein the cooling extruder screw can decrease the pressure in the melt.

18. An extrusion plant according to claim 13 wherein the cooling units are melt pumps in conjunction with heat exchangers.

19. An extrusion plant according to claim 1 wherein the control system for the cooling units can change the speed of the cooling units whereby the melt properties can be controlled.

20. A process to manufacture foamed products according to claim 9 further comprising influencing the material properties of the melt flows so that the material properties of the two melt flows are not identical.

21. A process according to claim 20 wherein the material properties of pressure and temperature are influenced.

22. A process according to claim 21 wherein deviation of the material properties from a desired value will affect the operating parameters of the cooling units, whereby the desired values of material properties will be obtained in the two melt flows.
